(19) United States
(12) Patent Application Publication
(10) Pub. No.: US 2007/0095400 A1
(43) Pub. Date: May 3, 2007

(54) SHUT-OFF VALVE SYSTEM

(75) Inventors: Thomas A. Bergquist, Simsbury, CT (US); Gary Pierko, East Hampton, CT (US); William Henninger, Southington, CT (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(73) Assignee: PARKER-HANNIFIN CORPORATION, Cleveland, OH (US)

(21) Appl. No.: 11/556,270

(22) Filed: Nov. 3, 2006

Related U.S. Application Data
(60) Provisional application No. 60/733,274, filed on Nov. 3, 2005.

(51) Int. Cl. F16K 31/12

(52) U.S. Cl. 137/485

(57) ABSTRACT

A shut-off valve system operative to shut-off flow through a pipe or other conduit in response to one or more fault conditions, including in particular high current that may cause damage to piping or other components downstream of the shut-off valve. The high current may result from a lightning strike inducing high current flow through the conduit and fluid flow components connected inline with the conduit.

### RELATED APPLICATIONS

This application claims the benefit of U.S. Provisional Application No. 60/733,274 filed Nov. 3, 2005, which is hereby incorporated herein by reference.

### FIELD OF THE INVENTION

The invention herein described relates generally to automatically actuated shut-off valves. More particularly, the invention relates to shut-off valve systems operative to shut-off flow through a pipe or other conduit in response to one or more fault conditions including high current that may cause damage to components downstream of the shut-off valve.

### BACKGROUND

Natural gas or water flows from municipal gas or water mains to customer locations. At a customer location, gas or water is routed through smaller pipes into a gas or water meter. Pipes then carry the gas or water into a customer residence or business where the gas or water is ultimately used by gas-consuming devices such as furnaces or by water-consuming devices such as faucets and washing machines.

Heretofore, various systems have been developed to shut-off gas or water flow in the event of an earthquake causing rupture of the smaller pipes leading into a residence or business. In the aftermath of an earthquake, the damage resulting from fires caused by gas pipe rupture or flooding from water pipe rupture can oftentimes exceed the damage resulting from shaking caused by the earthquake.

### SUMMARY OF THE INVENTION

The present invention provides a shut-off valve system operative to shut-off flow through a pipe or other conduit in response to one or more fault conditions, including in particular high current that may cause damage to components downstream of the shut-off valve. The high current may result from a lightning strike inducing high current flow through the conduit and fluid flow components connected inline with the conduit.

Accordingly, the invention provides a shut-off valve system comprising a valve openable and closable respectively to permit and shut-off flow through the valve; a current sensor for sensing electric current passing through the valve or a conduit to which the valve is connected and providing a current sensor output indicative of the sensed current; and a control device for receiving the output of the current sensor and causing the shut-off valve to close if a specified criteria is satisfied, thereby to shut-off flow through the valve and any downstream conduit connected thereto.

According to another aspect of the invention, a method for controlling the flow of fluid through a conduit, comprising the steps of using a current sensor to sense electric current passing through shut-off valve or a conduit to which the valve is connected and provide a current sensor output indicative of the sensed current; and causing the shut-off valve to close if a specified criteria is satisfied, the specified criteria including the current sensor output satisfying a specified current criteria.

Further features of the invention will become apparent from the following detailed description when considered in conjunction with the drawings.

### BRIEF DESCRIPTION OF THE DRAWINGS

In the annexed drawings,

FIG. 1 is a diagrammatic illustration of an exemplary shut-off valve system according to the invention;

FIG. 2 is a perspective cross-sectional view of an exemplary shut-off valve system; and

FIG. 3 is a schematic view of an exemplary current sensing circuit useful in the shut-off valve system.

### DETAILED DESCRIPTION

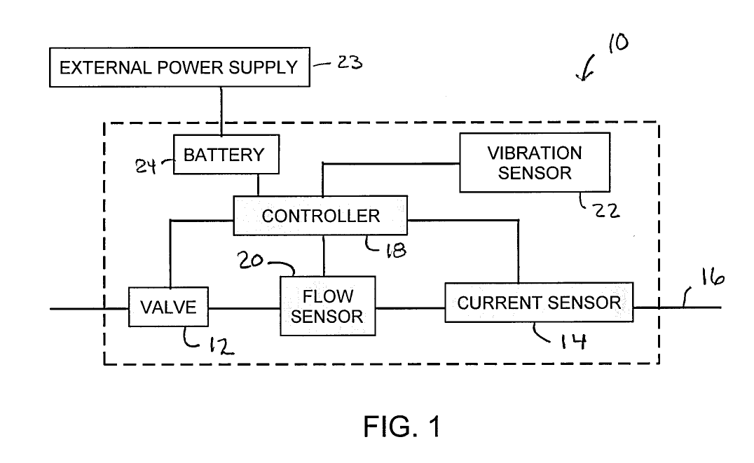

Referring now in detail to the drawings and initially to FIG. 1, an exemplary shut-off valve system according to the invention is designated generally by reference numeral 10. The valve system generally comprises a valve 12 openable and closable respectively to permit and shut-off flow through the valve; a current sensor 14 for sensing electric current passing through the valve or a conduit 16 to which the valve is connected and providing a current sensor output indicative of the sensed current; and a control device 18 for receiving the output of the current sensor and causing the shut-off valve to close if a specified criteria is satisfied, thereby to shut-off flow through the valve 12 and the downstream conduit 16 connected thereto. The system may also comprise a flow sensor 20, vibration sensor 22, and a power source for connection to an external power supply 23, or a battery 24 that may be used as a primary or more preferably as a backup power supply if external power is lost.

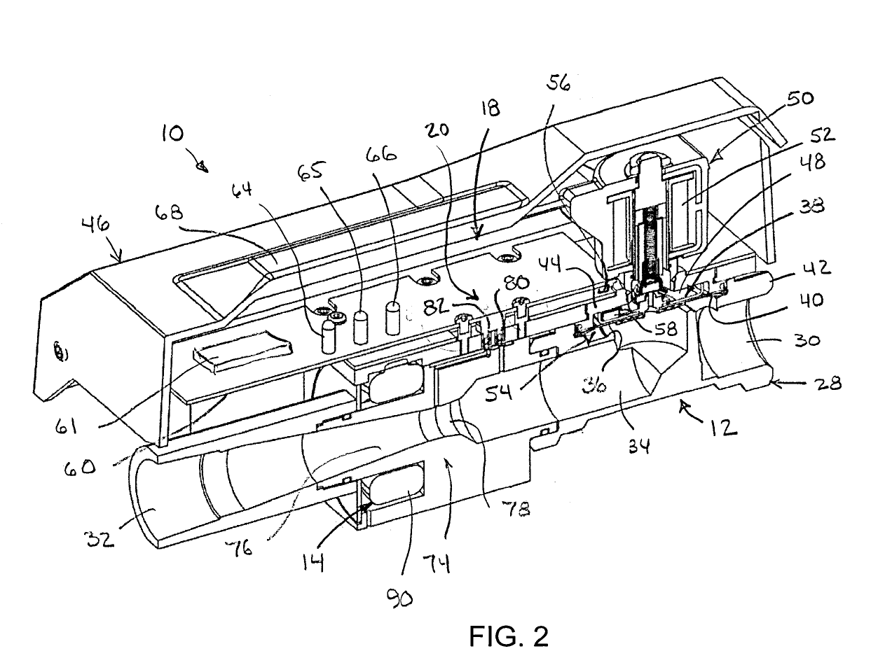

A physical manifestation of the shut-off valve system of FIG. 1 is illustrated in FIG. 2 wherein the same reference numbers are used to designate corresponding parts. As shown, the valve 12 includes a valve body 28 having inlet and outlet ports 30 and 32 that may be coaxial as shown or otherwise configured as desired for a given application. The illustrated valve body 28 has a circuitous flow passage 34 extending between the inlet port 30 and the outlet port 32. The flow passage 34 extends through an annular valve seat 36 for a movable valve member 38.

The valve member 38, for example, may be of a diaphragm type with the diaphragm 40 secured about it periphery between a main body portion 42 and a closure member 44. As shown, the central portion of the diaphragm may be supported by a valve plate 48 which has a diameter greater than the diameter of the annular valve seat 36, so that the valve plate will push the diaphragm against the valve seat when the valve is closed.

The valve member 38 is moved between open and closed positions by controllable actuator means such as a solenoid 50, for opening and closing the valve. The valve member 38 may be configured to be normally open, normally closed, bistable, or otherwise configured, as may be desired for a particular application. As shown, the solenoid may be mounted and sealed to the closure member 44.

The solenoid 50 includes a solenoid coil 52 that may be located within the interior of the housing 46 as shown. The coil 52 is connected to the control device 18 which is operable to energize and de-energize coil for closing and opening of the valve 12. A location sensor 54 may be provided for determining the location of the valve member 38. In the illustrated embodiment, the location sensor 54 includes a Hall effect sensor 56 that is located at a stationary position outside of the valve body and an associated permanent magnet 58 mounted on the movable valve member 38. The Hall effect sensor 56 may be conveniently mounted on a printed circuit board 60 located within the interior of the housing 46 and suitably connected to the control device 18.

The control device 18, also referred to as a controller, preferably includes a microprocessor 61, although any suitable controller may be used. The microprocessor is mounted on a printed circuit board 60 preferably enclosed within the housing 46. The printed circuit board 60 may also include any necessary voltage regulators, the drive circuitry for the solenoid 56, any necessary switches and test buttons, and indicators, such as light emitting diodes 64-66. The housing may have a view window 68 for allowing the diodes to be seen from outside the housing. The view window 68 may be formed, for example, by a transparent portion of a wall of the housing. Other arrangements may have the diodes or other indicators mounted outside the housing, or light pipes may be used to convey the light from the diodes for viewing from outside the housing.

The printed circuit board 60 may also have disposed thereon suitable power conversion circuitry for allowing operation of the system 10 by an available power supply, such as by electrical power from a typical electrical outlet or a transformer. Provision is also made for connection to the battery 24 that can provide the system with electrical power during the occurrence of an electrical outage. The housing 46 may include a battery compartment for receiving the battery.

The housing may also enclose the vibration sensor 22. The vibration sensor may include, for example, an accelerometer for measuring acceleration, which may be mouted to the printed circuit board 60. In an alternative arrangement, the accelerometer or other vibration sensor may be mounted outside the housing or even remote from the housing and valve 12, such as to the foundation of a building with which the shut-off valve system 10 is associated.

The housing may also enclose the electrical portion of the flow sensor 20. Although any suitable flow sensor may be used, in the illustrated embodiment the flow sensor is a differential pressure sensor that measures the difference in pressure upstream and downstream of a flow restriction in the flow passage 34, such as a venturi 74 that may be formed integrally with the valve body 28 or otherwise, such as in a separate structure attached to the valve body 12. The venturi 74 includes a passage 76 that tapers outwardly from a narrow inlet 78 toward the outlet port 32. In the illustrated embodiment, the outlet port 32 of the valve body is the outlet of the venturi 74. The venturi 74 preferably is configured to create laminar flow of the fluid flowing from the inlet 78 to the outlet port 32.

As shown, the valve body 12 has two sensor ports 80 and 82 in fluid communication with the flow passage 34 at locations upstream and downstream of the narrow inlet 78. The differential pressure sensor 20 includes pressure transducer having probe portions respectively associated with the sensor ports for measuring the pressure at each port. The pressure transducers, which may be conveniently mounted to the printed circuit board, are connected to associated circuitry on the circuit board for providing to the microprocessor signals from which can be determined the rate of flow of fluid through the passage 34.

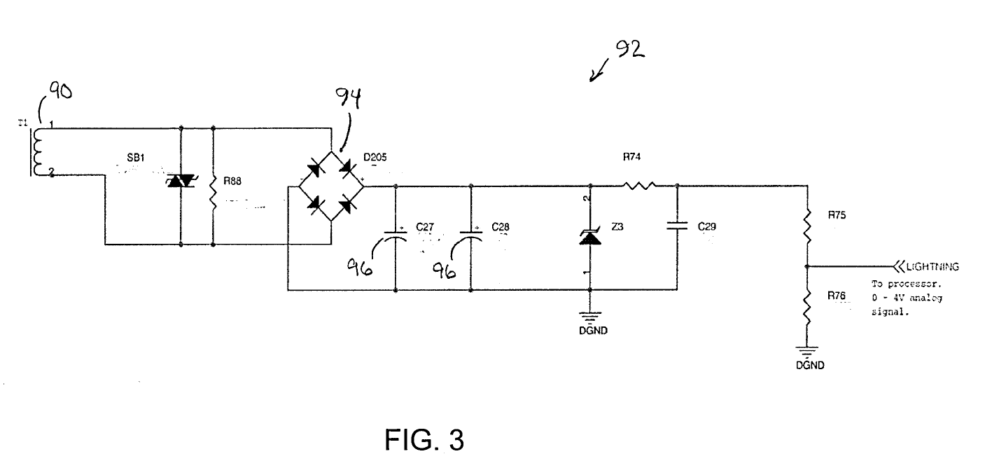

The microprocessor also receives signals from the current sensor. Although any suitable type of current sensor may be used, in the illustrated embodiment the current sensor includes a current sensing coil 90 for monitoring any current that may pass through the valve body 28, as might arise from a lightning strike. The coil 90 may be wound on a toroidal core or similar type device used to detect current flowing through the valve body. In the exemplary current circuit 92 illustrated in FIG. 3, induce current may flow from the coil 90 into a full bridge rectifier circuit 94 that converts either a positive or negative lightning pulse to a positive direct current. The direct current charges one or more capacitors 96 to a voltage equivalent to the current charge received. The capacitor also function as an accumulator to store the induced energy from the lightning strike for a sufficient time to enable the signal to be processed. The balance of the components of the circuit shown in FIG. 3 are provided for signal conditioning. The voltage output of the circuit is compared, for example, to known levels of voltage that may result in pipe or other component damage associated with the conduit protected by the shut-off valve system 10. A comparison circuit may provide an output signal for closing the valve 10 when there is a possibility of component damage, such as damage that may cause a leak.

The comparison voltage level may be adjustable to accommodate system components that may require more or less current to cause damage to components. A microprocessor-based device or discrete electronic components may be used to form the comparison circuit.

Any suitable criteria may be used to determine when the system shuts the valve in response to a lightning strike (of other high current spike or surge). For instance, the system may effect valve closure if the measured current exceeds a certain threshold, such as 1000 amps. Other arrangements may control valve closure as a function of current and time. In still other arrangements, a sensed current pulse or surge meeting a specified criteria may be used to initiate a leak testing routine such as that described below, in which case the valve would be closed only if a leak is also detected. Another arrangement is to close the valve in the event of a potentially damaging current pulse or surge, and then testing for a leak and re-opening the valve if no leak is detected.

As will be appreciated, the shut-off valve system 10 may be used to protect any fluid conduit system against current spikes or surges, as may arise from a lightning strike. The fluid being conveyed through the system may be any fluid such as natural gas, water, industrial chemicals, etc. Operation of the system will now be described in relation to a gas piping system, although it should be understood the fluid could be a fluid other than gas.

As noted, the system 10 of the present invention may be used in a gas piping system for shutting down (blocking) gas flow in response to detecting a lightning strike, and additionally a gas leak or earthquake event. By monitoring the differential pressure across the venturi and providing pressure information to the controller, the system can determine whether a gas leak is present in the fluid piping located downstream of the system. To determine if a gas leak is present downstream of the system 10, for example, the controller may operate the solenoid to close the valve member for a predetermined period of time. The controller then may reopen the valve member to enable gas flow through the flow passage of the valve body. When the valve member is reopened, the pressure sensor may monitor for a pressure pulse through the venturi. When a pressure pulse exceeding a predetermined level is present (or satisfying some other specified criteria), a gas leak is determined to exist and the controller again closes the valve member to stop the flow of gas through the valve body. When the pressure pulse does not exceed the predetermined level, the controller determines that no gas leak is present and continues to enable the flow of gas through the valve body. The predetermined level of the pressure pulse is greater than a level that occurs from the use of a pilot light downstream of the valve.

The controller also may be configured to establish a base flow for the gas piping by monitoring the flow through the valve body at a predetermined frequency, such a 500 times per second. In response to the occurrence of seismic activity of a predetermined level, determined using the accelerometer of the system, the controller may determine if a gas leak has arisen by any suitable means. When the controller determines that a gas leak has arisen, the controller closes the valve member to stop the flow of gas through the valve body and provides an alert that a gas leak has been detected. The alert may be an indication using the light emitting diodes and/or may include an audible indication. The alert may also be transmitted to a remote location, such as a monitoring station, either by wire or wirelessly, as may be desired.

In accordance with the present invention, the controller is responsive to the presence of a current satisfying a specified criteria, such as the current exceeding a predetermined threshold amperage through the valve body. The predetermined threshold may be an amount of amperage that may result in a gas leak in the piping downstream of the valve. In response to receiving a signal from the current sensor that the predetermined threshold (or other criteria) has been exceeded, the controller may immediately shut-off flow or first perform a leak detection test to monitor for a pressure pulse in the same manner as discussed above. When the controller determines that a gas leak has arisen, the controller closes the valve member to stop the flow of gas through the valve body and provides an alert that a gas leak has been detected.

The system may also be configured for determining the presence of a gas leak downstream of the valve body that occurs for any reason. For example, when the gas leak results from improper installation, the above-described leak test that monitors for a pressure pulse in the venturi may be performed for determining the existence of the leak.

The valve may also be closed when a fire is detected by an on board fire detection circuit or by remote alarm input signal. External input connections for remote alarms may be provided. Optionally, the valve may include a manual shutoff circuit to allow for gas shutoff for repair and/or replacement of components.

The system may also respond to the vibration sensor sensing vibration satisfying a specified criteria, such as may be indicative of an earthquake. The system may immediately shut the valve and/or initiate a leak testing procedure before or after shutting the valve.

Operation status may be indicated by LEDs (or other indicating devices) for valve operation, battery charge, and/or alarm. High voltage damage protection provides circuit protection from lightning strike discharge, electrical shorting to piping, etc. The backup battery circuit provides power in the event of input AC power failure. The backup battery is recharged by internal power supply when input power is available.

AC ground connection to the system components may be provided. This ground may also provide a path for lightning discharge current through the piping system, which will be sensed by the current sensor.

Accordingly, the invention provides a valve system with one or more of the following features and functions:

(1) the system may continuously monitor valve position to verify and provides visual indication of valve position;

(2) the electronics may continuously monitor seismic activity and will activate the leakage test mode if levels exceed those required by industry codes;

(3) the system may shut off gas to homeowner or business only if a leak is detected a prescribed number of minutes following a minimum level earthquake;

(4) the system may monitor flow 500 times a second to establish baseline flow prior to earthquake;

(5) the system may be self-calibrating to each home based on temperature variations and usage;

(6) the system may self-check operation monthly and notify home or business owner of possible failure;

(7) the battery may last for 24 hours in the case of a power outage;

(8) the electronics may continuously monitor for excessive current in the gas piping system and will shut down if detected; and

(9) the system may verify that piping system installation is without any leaks.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A shut-off valve system comprising:
a valve openable and closable respectively to permit and shut-off flow through the valve;
a current sensor for sensing electric current passing through the valve or a conduit to which the valve is connected and providing a current sensor output indicative of the sensed current; and
a control device for receiving the output of the current sensor and causing the shut-off valve to close if a specified criteria is satisfied, thereby to shut-off flow through the valve and any downstream conduit connected thereto.

2. A shut-off valve system as set forth in claim 1, wherein the valve includes a valve body and a valve member, the valve member having a first position for enabling a flow of fluid through the valve body and a second position for blocking the flow of fluid through the valve body; and a solenoid operable for moving the valve member between the first and second positions.

3. A shut-off valve system as set forth in claim 2, comprising a flow sensor for sensing flow through the valve and providing to the control device a flow sensor output indicative of the sensed flow, and wherein the control device is operative to determine whether a leak exists downstream of the valve and, in response to determining that a leak exists, to cause the solenoid to move the valve member into the second position.

4. A shut-off valve system as set forth in claim 3, wherein the current sensor senses electric current passing through the valve body.

5. A shut-off valve system as set forth in claim 4, wherein the control device determines whether a leak exists downstream of the valve in response to the current sensor sensing a current that exceeds a predetermined threshold.

6. A method for controlling the flow of fluid through a conduit, comprising the steps of:
using a current sensor to sense electric current passing through shut-off valve or a conduit to which the valve is connected and provide a current sensor output indicative of the sensed current; and
causing the shut-off valve to close if a specified criteria is satisfied, the specified criteria including the current sensor output satisfying a specified current criteria.
